(19) United States
(12) Patent Application Publication
(10) Pub. No.: US 2013/0264156 A1
(43) Pub. Date: Oct. 10, 2013

(54) BRAKE ROTOR ASSEMBLY

(71) Applicant: John P. DeConti, Bristol, CT (US)

(72) Inventor: John P. DeConti, Bristol, CT (US)

(73) Assignee: D-BRAKE LLC, New Britian, CT (US)

(21) Appl. No.: 13/439,310

(22) Filed: Apr. 4, 2012

(51) Int. Cl. F16D 65/12; B23P 11/00

(52) U.S. Cl. 188/218 XL; 29/428

(57) ABSTRACT

A brake rotor includes a first disc member having a first body provided with a first braking surface, a first inner surface and a first annular rim. The first annular rim includes a first groove and one or more connection elements. A second disc member includes a second body having a second braking surface, a second inner surface and a second annular rim. The second annular rim includes a second groove and one or more connection members. The connection members are configured and disposed to register with corresponding ones of the connection elements such that the first groove aligns with the second groove. A linking member extends within the first and second grooves to detachably join the first and second disc members.

### BACKGROUND OF THE INVENTION

Exemplary embodiments pertain to the art of braking systems and, more particularly, to a brake rotor assembly for a liquid cooled braking system.

Many braking systems employ rotors that provide structure that is acted upon by friction pads to slow rotation of a wheel. The use of friction pads generates heat in the rotors. As such, many rotors are provided with cooling arrangements. Cooling arrangements include air cooling arrangements and liquid cooling arrangements. Many rotors that include air cooling arrangements are formed with first and second opposing disc members joined by a plurality of cooling vanes. The cooling vanes generate a cooling airflow when the rotor spins. Rotors having liquid cooling arrangements generally include first and second disc members joined to one another to form an internal cooling volume. One method of assembly utilizes a heated bonding process such as welding, brazing, and/or soldering to join the first and second discs. A second method of assembly joins the first and second discs through a threaded connection. Regardless of the method of assembly, a liquid is pumped through the internal cooling volume to lower temperatures of the first and second discs. In some cases, the internal volume includes vanes that facilitate liquid movement when the rotor spins.

### BRIEF DESCRIPTION OF THE INVENTION

Disclosed is a brake rotor including a first disc member having a first body provided with a first braking surface, a first inner surface and a first annular rim defining a first cavity. The first annular rim includes a first groove and one or more connection elements. A second disc member includes a second body having a second braking surface, a second inner surface and a second annular rim defining a second cavity. The second annular rim includes a second groove and one or more connection members. The one or more connection members are configured and disposed to register with corresponding ones of the one or more connection elements such that the first groove aligns with the second groove. A linking member detachably joins the first and second disc members. The linking member extends within the first and second grooves to secure the first disc member to the second disc member.

Also disclosed is a method of joining first and second disc members of a brake rotor. The method includes positioning a first disc member having a first braking surface, a first inner surface, a first outer surface and a first annular rim adjacent to a second disc member having a second braking surface, a second outer surface, a second inner surface and a second annular rim. The method also includes registering one or more connection elements provided on the first annular rim with one or more connection members provided on the second annular rim, aligning a first groove provided on an inner surface of the first annular rim with a second groove provided on an outer surface of the second annular rim, and inserting a linking member into the first and second grooves to join the first disc member to the second disc member.

### BRIEF DESCRIPTION OF THE DRAWINGS

The following descriptions should not be considered limiting in any way. With reference to the accompanying drawings, like elements are numbered alike:

FIG. 1 depicts a perspective view of a brake rotor assembly including a drive plate joined to a seal plate in accordance with an exemplary embodiment;

FIG. 2 depicts a perspective view of the brake rotor assembly of FIG. 1 with the seal plate removed to reveal an inner rotor and a stator;

FIG. 3 depicts a perspective view of the brake rotor assembly of FIG. 2 without the stator;

FIG. 4 depicts a cross-sectional view of the brake rotor assembly in accordance with an exemplary embodiment;

FIG. 5 depicts a perspective view of an seal being installed into a seal receiving groove formed in an inner surface of the seal plate;

FIG. 6 depicts a perspective view of an inner surface of the drive plate;

FIG. 7 depicts a partial cross-sectional view of the drive plate joined to the seal plate with a linking member in accordance with an aspect of the exemplary embodiment;

FIG. 8 is a plan view of the drive plate joined to the seal plate of FIG. 7;

FIG. 9 is a plan view of the linking member of FIG. 7;

FIG. 10 depicts a partial plan view of the drive plate joined to the seal plate with a linking member in accordance with another aspect of the exemplary embodiment;

FIG. 11 depicts a partial plan view of the drive plate joined to the seal plate with a linking member in accordance with yet another aspect of the exemplary embodiment;

FIG. 12 depicts a partial cross-sectional view of the drive plate joined to the seal plate with a linking member in accordance with still yet another aspect of the exemplary embodiment;

FIG. 13 is a plan view of the drive plate joined to the seal plate of FIG. 12;

FIG. 14 is a plan view of the linking member of FIG. 12;

FIG. 15 is a perspective view of a drive plate having a metal matrix composite (MMC) member in accordance with another aspect of the exemplary embodiment; and

FIG. 16 is a perspective view of a seal plate having a MMC member in accordance with another aspect of the exemplary embodiment.

### DETAILED DESCRIPTION OF THE INVENTION

A detailed description of one or more embodiments of the disclosed apparatus and method are presented herein by way of exemplification and not limitation with reference to the Figures.

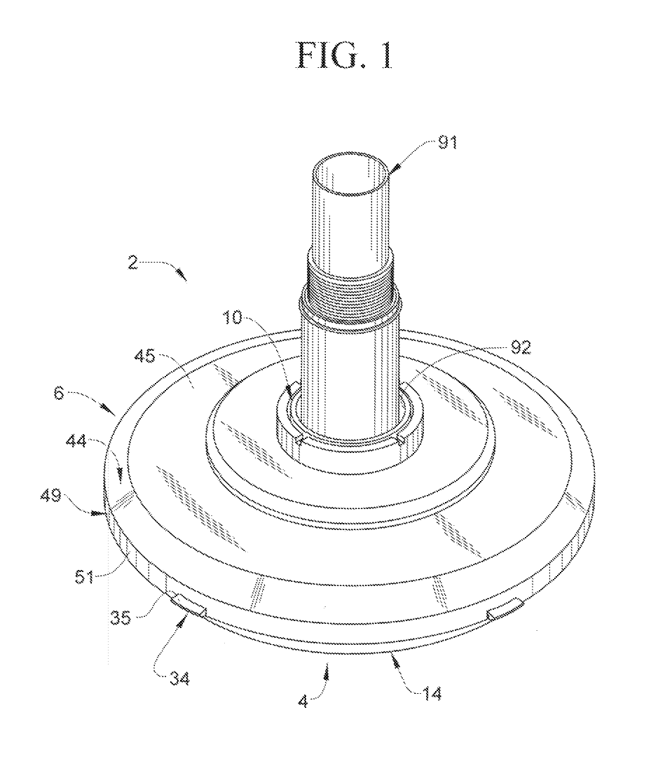

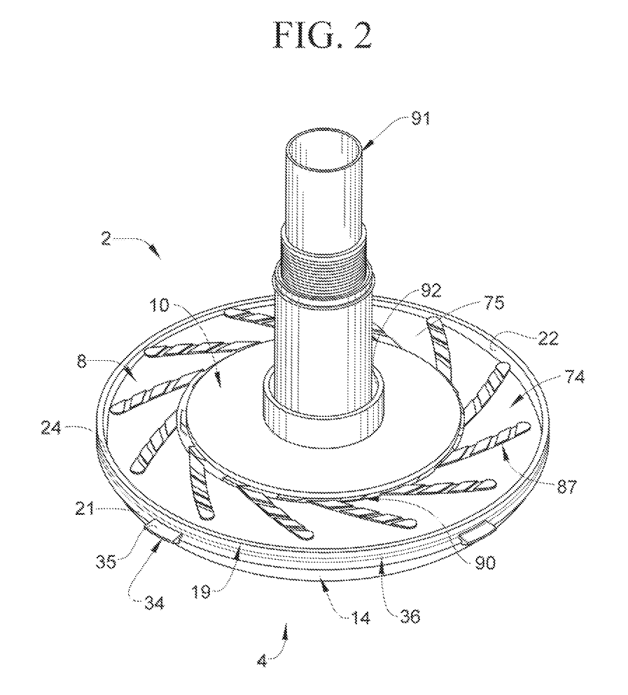

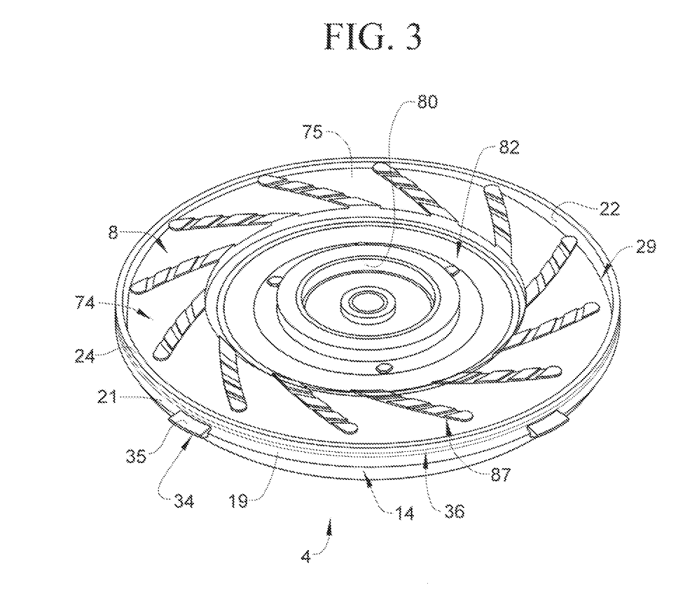

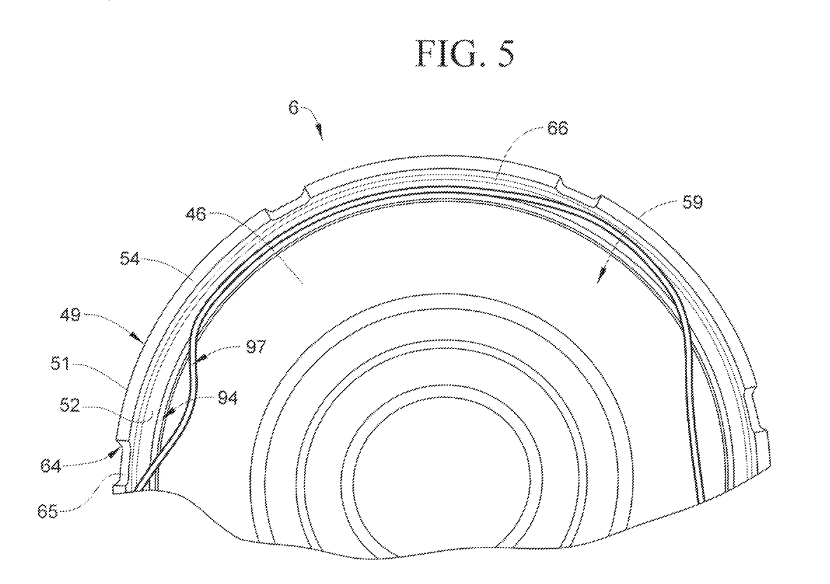

With reference to FIGS. 1-6, a brake rotor assembly constructed in accordance with an exemplary embodiment is indicated generally at 2. Brake rotor assembly 2 includes a first disc member or drive plate 4, a second disc member or seal plate 6, an inner rotor 8 and a stator 10. Drive plate 4 includes a first body 14 having a first braking surface 15, a first inner surface 16, and a first annular rim 19. First annular rim 19 includes a first outer annular rim surface 21, a first inner annular rim surface 22, and a first annular edge 24. First inner surface 16 and first inner annular rim surface 22 define a first cavity 29. In accordance with one aspect of the exemplary embodiment, drive plate 4 includes a plurality of connection elements, one of which is indicated at 34. In the exemplary embodiment shown, connection elements 34 take the form of tabs 35 that project radially outward from first outer annular rim surface 21. Drive plate 4 is also shown to include a first groove 36 and extends about first annular rim 19. In the exemplary embodiment shown, first groove 36 is arranged between first annular edge 24 and the plurality of connection elements 34 on first outer annular rim surface 21.

Seal plate 6 includes a second body 44 having a second braking surface 45, a second inner surface 46, and a second annular rim 49. Second annular rim 49 includes a second outer annular rim surface 51, a second inner annular rim surface 52 and a second annular edge 54. Second inner surface 46 and second inner annular rim surface 52 collectively define a second cavity 59. Seal plate 6 is also shown to include a plurality of connection members, one of which is indicated at 64. In the exemplary embodiment shown, connection members 64 take the form of notches 65 formed at second annual edge 54. Notches 65 are sized and arranged to receive corresponding ones of the plurality of tabs 35. Seal plate 6 is also shown to include a second groove 66 that is positioned to register with first groove 36 when connection elements 34 nest within connection members 64. Specifically, second groove 66 is provided on second inner annular rim surface 52. At this point it should be understood that the number of connection elements 34 and connection members 64 could vary. In the exemplary embodiment shown, drive plate 4 and seal plate 6 are formed from 4032 aluminum.

In further accordance with the exemplary embodiment, inner rotor 8 includes an inner rotor body 74 that is received within first and second cavities 29 and 59. Inner rotor body 74 includes a first inner rotor surface 75 and a second inner rotor surface 76 that are joined by an outer edge 78. Inner rotor body 74 is also shown to include a central opening 80. A recessed portion 82 is formed in first inner rotor surface 75 about central opening 80. A raised region (not shown) is formed in second inner rotor surface 76 about central opening 80. Recessed portion 82 is configured to receive stator 10 while the raised region (not shown) is positioned to be received within a concentric groove 84 (FIG. 6) formed in first inner surface 16 of drive plate 4. First inner surface 16 is also shown to include a drive pin receiver 85. Drive pin receiver 85 is configured to receive a drive pin (not shown) that connects inner rotor 8 with drive plate 4. In this manner, inner rotor 8 is rotationally fixed relative to drive plate 4.

Inner rotor 8 also includes a first plurality of blades 87 formed on first inner rotor surface 75, and a second plurality of blades 89 formed on second inner rotor surface 76. First and second pluralities of blades 87 and 89, along with a plurality of stator blades 90 formed on stator 10, pump a cooling fluid through first and second cavities 29 and 59 as will be discussed more fully below. Stator 8 includes a cooling fluid inlet 91 and a cooling fluid outlet 92 that guide cooling fluid into and out from first and second cavities 29 and 59. As will be detailed more fully below, drive plate 4 is joined to seal plate 6 with inner rotor 8 being arranged within first and second cavities 29 and 59. In the exemplary embodiment shown, seal plate 6 includes a seal receiving groove 94 formed in second inner surface 46 adjacent second inner annular rim surface 52. Seal receiving groove 94 receives a seal 97 that provides a seal between drive plate 4 and seal plate 6. Specifically, when seal plate 6 is mounted to drive plate 4, first annular edge 24 compresses seal 97 to form a seal.

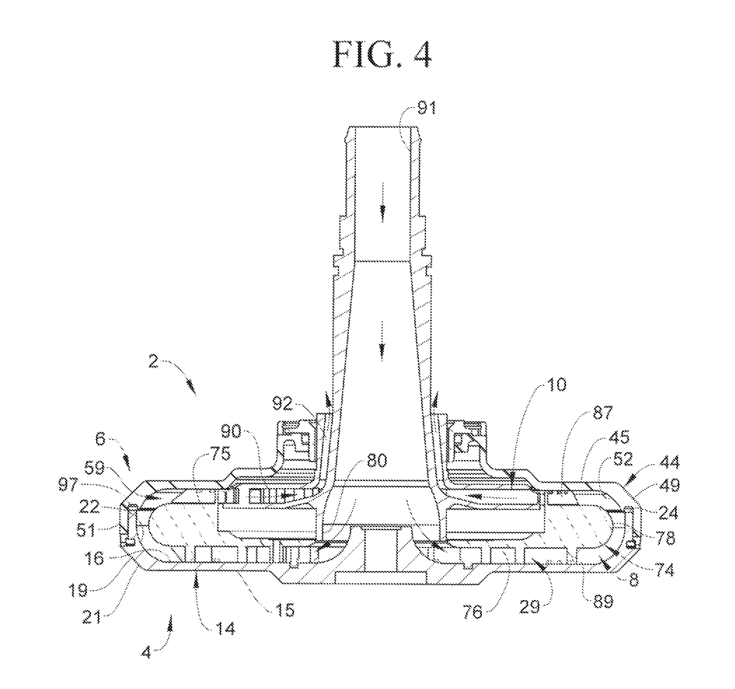

Inner rotor 8 rotates with drive plate 4 and seal plate 6 to pump cooling fluid through first and second cavities 29 and 59 to absorb heat from first and second braking surfaces 15 and 45. As best shown in FIG. 4, cooling fluid enters through cooling fluid inlet 91, passes through central opening 80 of inner rotor 8, enters first cavity 29 and flows over first inner surface 16 to cool first braking surface 15. Second plurality of blades 89 directs the cooling fluid radially outward toward and around outer edge 78. The cooling fluid passes onto first inner rotor surface 75 to cool second braking surface 45. The cooling fluid is acted upon by the first plurality of blades 87 and guided toward stator blades 90. The cooling fluid passes into stator 10 and then flows through cooling fluid outlet 92. The cooling fluid is cooled and then reintroduced into brake rotor assembly 2. At this point it should be understood that in addition to providing a motive force that urges cooling fluid through first and second cavities 29 and 59, first and second pluralities of blades 87 and 89 provide support to first and second inner surfaces 16 and 46 when a braking force is applied to braking surfaces 15 and 45.

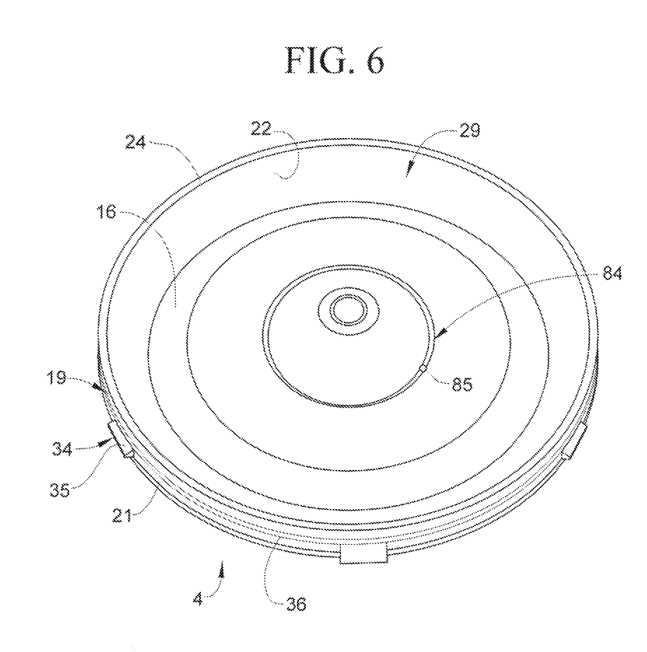

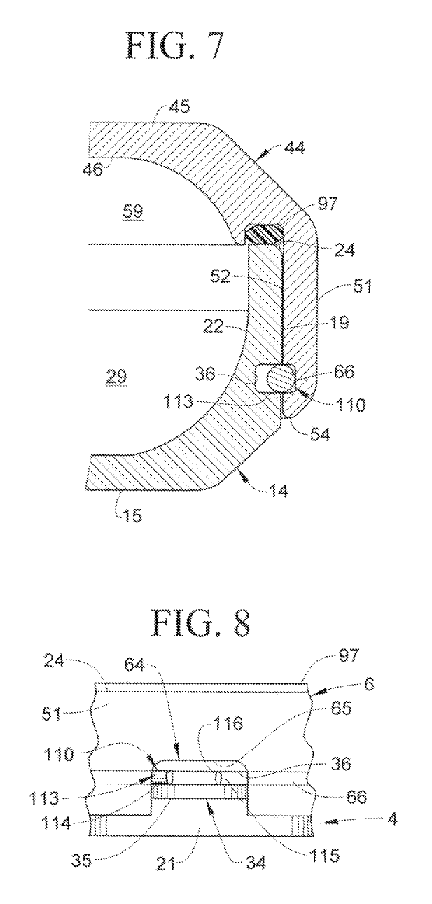

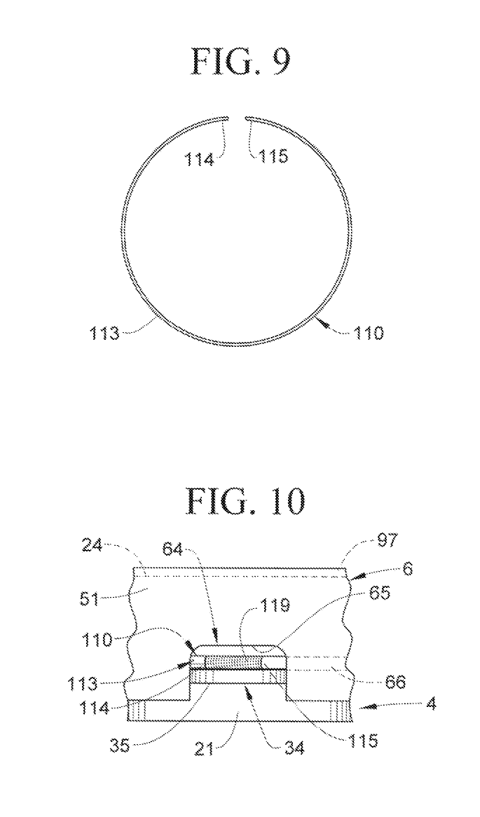

In accordance with an exemplary embodiment illustrated in FIGS. 7 and 8, drive plate 4 is joined to seal plate 6 such that the plurality of connection elements 34 register with corresponding ones of the plurality of connection members 64 such that first groove 36 aligns with second groove 66 and first annular edge 24 abuts seal 97. In addition to providing any desired alignment, connection elements 34 transmit torque from seal plate 6 to drive plate 4. As such, it should be understood that while shown as being in the form of tabs 35 and notches 65, connection elements 34 and connection members 64 could take on a variety of forms that may transmit torque between two members. After connection elements 34 register with connection members 64, a linking member 110 such as shown in FIG. 9 is inserted into first and second grooves 36 and 66. Linking member 110 prevents separation of drive plate 4 and seal plate 6.

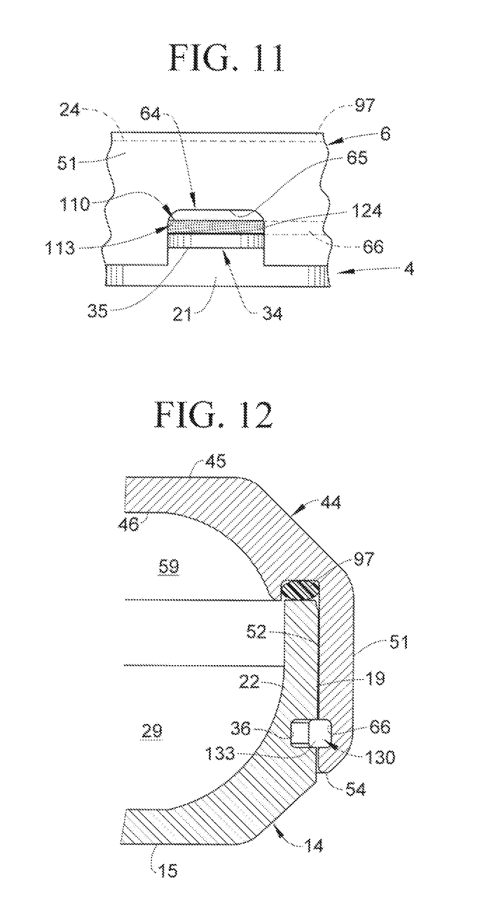

In accordance with one aspect of the exemplary embodiment, linking member 110 takes the form of a length of wire 113. Length of wire 113 is formed into a ring like shape having first and second free ends 114 and 115 and inserted into groove 36 such as shown in FIGS. 8 and 9. At this point, seal plate 6 is guided onto drive plate 4 and compressed until wire 113 snaps into groove 66. Of course, it should be understood that linking member 110 may be compressed using a compression device prior to the installation of seal plate 6, or may take the form of multiple lengths of wire inserted into first and second grooves 36 and 66 at various positions about rotor assembly 2. In addition, an amount of adhesive 116 may be positioned within first and second grooves 36 and 66 to constrain free ends 114 and 115. Adhesive 116 may take the form of an epoxy or the like. FIG. 10 illustrates an amount of plastic filler material 119 positioned within first and second grooves 36 and 66 to constrain first and second free ends 114 and 115. FIG. 11 illustrates linking member 110 as being a plastic filler material 124 injected into first and second grooves 36 and 66. To disassemble seal plate 6 from drive plate 4, linking member 110 is compressed into one of the first and second grooves 36 and 66. Once linking member 110 is compressed, a press, compressed air, or other tool may be employed to separate seal plate 6 from drive plate 4.

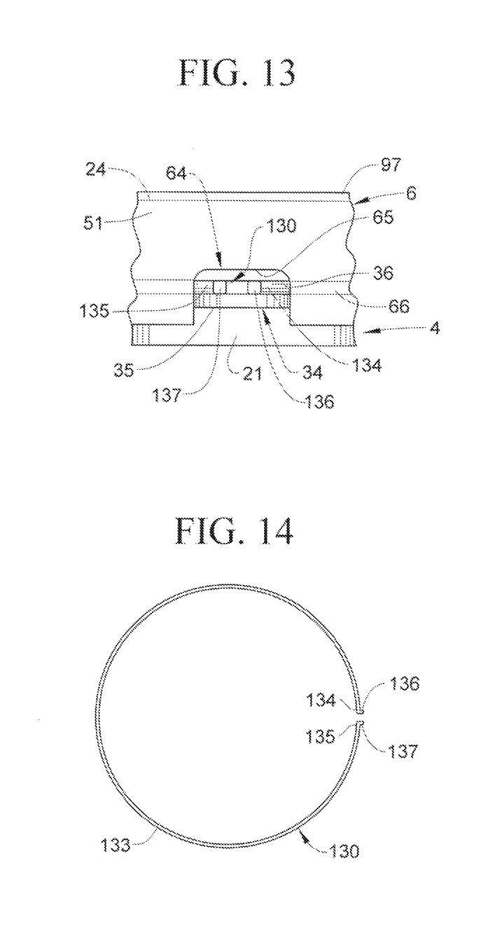

FIGS. 12-14 illustrate a linking member 130 in accordance with another aspect of the exemplary embodiment. Linking member 130 includes a length of wire 133 having first and second free ends 134 and 135. Each free end 134 and 135 includes a corresponding bend portion 136 and 137 that project generally radially outward from linking member 130. Bend portions 136 and 137 provide gripping surfaces for a tool, such as a plier, that may be used to compress linking member 130 into first groove 36 to facilitate installation of seal plate 6 to drive plate 4. Bend portions 136 and 137 also aid in disassembly of brake rotor assembly 2.

Regardless of form, linking member 110 provides a robust link between drive plate 4 and seal plate 6 while at the same time allowing for occasional separation for maintenance purposes. In prior art arrangements, separation of the drive plate and the seal plate would require burning, cutting or another destructive process that often times results in damage to one or more of the components. In contrast, the present invention allows for the drive plate to be joined to the seal plate without using thermal bonding process so as to allow for ready separation for repair and/or replacement of one or more components. The removal of a thermal bonding process from an overall assembly operation eliminates thermal stresses and resulting thermal distortions during assembly. The linking member not only provides the desired joint, but connection elements and connection members provide the desired torque transfer capabilities that ensure that rotor assembly is operational for a prolonged period between maintenance cycles.

In addition, the use of 4032 aluminum provides for a rotor assembly having a significant cost and weight reduction over prior art systems as well as desired heat transfer qualities that extend an overall service life of the brake assembly and corresponding components such as brake pads and the like. In addition 4032 aluminum, being a forged material, possesses minimal inclusions and a lower porosity that leads to enhanced cracking resistance over other aluminum alloys. 4032 aluminum also possesses a high percentage of silica which leads to enhanced wear resistance over other aluminum alloys. Other materials, such as forged copper possess similar qualities but have various disadvantages such as increased cost, weight, as well as being more difficult to machine. However, it should be understood that while described as being formed from 4032 aluminum, drive plate 4 and seal plate 6 could be formed from other materials such as, for example, copper.

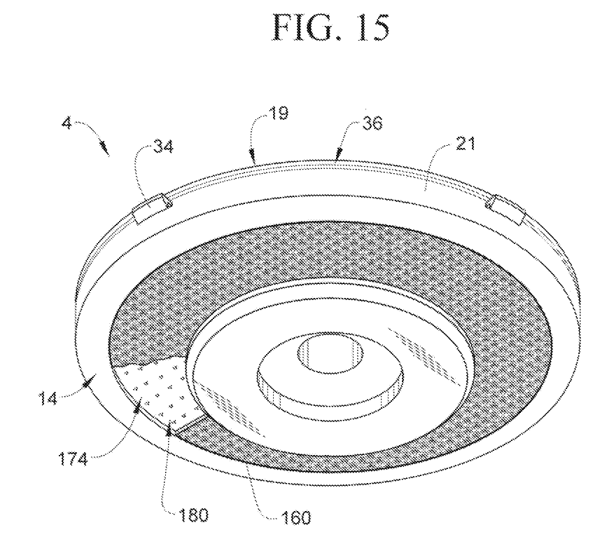

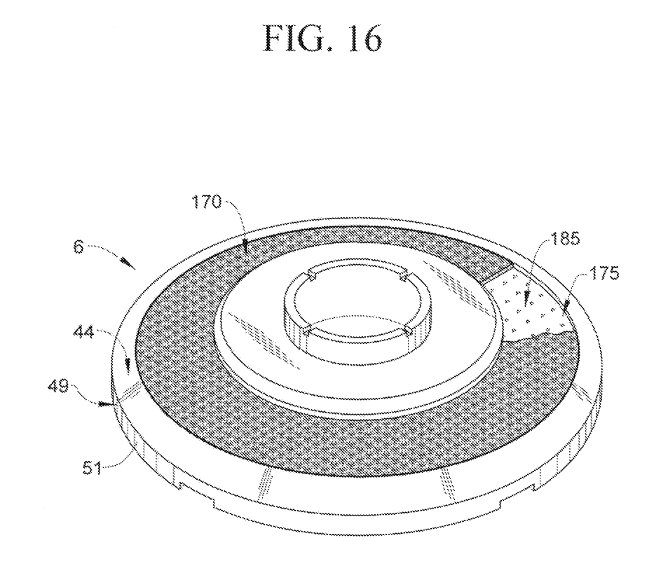

Reference will now be made to FIGS. 15 and 16 wherein like reference numbers represent corresponding parts in the respective views, in describing drive plate 4 and seal plate 6 in accordance with another aspect of the exemplary embodiment. As shown in FIG. 15, first braking surface 15 is replaced with a metal matrix component (MMC) member 160. Similarly, FIG. 16 illustrates a MMC member 170 replacing second braking surface 45. MMC members 160 and 170 provide added wear resistance for braking surfaces 15 and 45 while at the same time increasing energy absorption capability. In accordance with one aspect, MMC members 160 and 170 are provided in drive plate 4 and seal plate 6 respectively.

In accordance with one aspect of the exemplary embodiment, MMC members 160 and 170 are cast into recesses 174 and 175 formed in drive plate 4 and seal plate 6 respectively. More specifically, molten MMC material is provided in cavities 174 and 175. The molten MMC material solidified to form MMC members 160 and 170 having a metallurgical bond with drive plate 4 and seal plate 6 respectively. Recesses 174 and 175 may include various mechanical linking features shown generally at 180 in FIG. 15 and 185 in FIG. 16 that facilitate a mechanical bond between corresponding ones of MMC members 160 and 170 and drive plate 4 and seal plate 6. Mechanical linking features 180 and 185 may take on a variety of forms including dovetails, grooves and the like (also not shown) that enhance the metallurgical bond. In accordance with another exemplary aspect, MMC members 160 and 170 initially start out as silicon carbide preforms (not separately labeled) The silicon carbide preforms are infiltrated under vacuum or pressure to respective ones of drive plate 4 and seal plate 6 to form a metallurgical bond. Infiltration also transforms the silicon carbide preforms to MMC members 160 and 170. At this point it should be understood that MMC members 160 and 170 can be formed using other processes. For example, drive plate 4 and seal plate 6 could be cast around the MMC. In addition, drive plate 4 and seal plate 6 may be formed from aluminum 356.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A brake rotor assembly comprising:
a first disc member including a first body having a first braking surface, a first inner surface and a first annular rim defining a first cavity, the first annular rim including a first groove and one or more connection elements;
a second disc member including a second body having a second braking surface, a second inner surface, and a second annular rim defining a second cavity, the second annular rim including a second groove and one or more connection members, the one or more connection members being configured and disposed to register with corresponding ones of the one or more connection elements such that the first groove aligns with the second groove; and
a linking member detachably joining the first and second disc members, the linking member extending within the first and second grooves to secure the first disc member to the second disc member.

2. The brake rotor assembly according to claim 1, wherein the linking member constitutes a length of wire.

3. The brake rotor assembly according to claim 2, wherein the length of wire constitutes a wire ring.

4. The brake rotor assembly according to claim 3, wherein the length of wire includes first and second free ends, each of the first and second free ends including a bend portion that projects radially outward from the wire ring.

5. The brake rotor assembly according to claim 2, further comprising: an amount of adhesive material positioned in the groove, the amount of adhesive securing the length of wire to each of the first and second disc members.

6. The brake rotor assembly according to claim 2, further comprising: an amount of plastic filler material positioned in the groove.

7. The brake rotor assembly according to claim 1, wherein the linking member constitutes an amount of plastic filler material.

8. The brake rotor assembly according to claim 1, further comprising: an inner rotor member arranged between the first and second disc members within the first and second cavities, the inner rotor member including a first surface and an opposing second surface, the first surface including a first plurality blades and the second surface including a second plurality of blades.

9. The brake rotor assembly according to claim 8, wherein the first plurality of blades abut the first inner surface and the second plurality of blades abut the second inner surface so as to support compressive forces applied to the first and second braking surfaces.

10. The brake rotor assembly according to claim 1, wherein one of the first and second disc members includes a seal receiving groove formed on one of the first and second inner surfaces.

11. The brake rotor assembly according to claim 10, further comprising: a seal positioned in the seal receiving groove formed in the ones of the first and second disc members, the Seal abutting an outer surface of the one of the first and second annular rims of the other of the first and second disc members.

12. The brake rotor assembly according to claim 1, wherein each of the first and second disc members is formed from 4032 aluminum.

13. The brake rotor assembly according to claim 1, wherein the first disc member is joined to the second disc member without a thermal bonding process.

14. The brake rotor assembly according to claim 1, wherein the first groove is provided on an inner surface of the first annular rim and the second groove is provided on an outer surface of the second annular rim.

15. The brake rotor assembly according to claim 1, wherein the one or more connection elements comprise a plurality of connection elements and the one or more connection member comprise a plurality of connection members.

16. The brake rotor assembly according to claim 15, wherein the plurality of connection elements comprise tabs that project axially outward from the first annular rim, and the plurality of connection members comprise notches formed in the second annular rim.

17. The brake rotor assembly according to claim 1, further comprising: at least one metal matrix composite (MMC) member bonded to one of the first and second disc members, the at least one MMC member defining a braking surface.

18. A method of joining first and second disc members of a brake rotor, the method comprising:
positioning a first disc member having a first braking surface, a first inner surface, a first outer surface and a first annular rim adjacent to a second disc member having a second braking surface, a second outer surface, a second inner surface and a second annular rim;
registering one or more connection elements provided on the first annular rim with one or more connection members provided on the second annular rim;
aligning a first groove provided on an inner surface of the first annular rim with a second groove provided on an outer surface of the second annular rim; and
inserting a linking member into the first and second grooves to join the first disc member to the second disc member.

19. The method of claim 18, wherein inserting the linking member into the first and second grooves includes installing the linking member into one of the first and second grooves and compressing the second disc member onto the first disc member causing the linking member to snap-fittingly engage into the other of the first and second grooves.

20. The method of claim 19, further comprising: inserting an amount of plastic filler material into the first and second grooves.

21. The method of claim 19, further comprising: applying an amount of adhesive into one of the first and second grooves to retain the length of wire.

22. The method of claim 18, wherein inserting the linking member into the first and second grooves includes injecting an amount of plastic filler material into the first and second grooves.

23. The method of claim 18, further comprising:
positioning an seal into an seal receiving groove formed on the first inner surface; and
compressing the seal with the second annular rim.

24. The method of claim 18, further comprising: positioning an inner rotor member having first and second outer surfaces between the first and second disc members.

25. The method of claim 18, further comprising: bonding a first metal matrix composite (MMC) member the first disc member and a second MMC member to the second disc member, the first and second MMC members defining the braking surfaces of the first and second disc members, respectively.

26. The method of claim 18, wherein inserting the linking member includes compressing the linking member into one of the first and second grooves.
